(19) United States
(12) Patent Application Publication
(10) Pub. No.: US 2016/0178905 A1
(43) Pub. Date: Jun. 23, 2016

(54) FACILITATING IMPROVED VIEWING CAPABITLIES FOR GLASS DISPLAYS

(71) Applicant: INTEL CORPORATION, Santa Clara, CA (US)

(72) Inventors: TOMER RIDER, Nahariya (IL); SHAHAR TAITE, Kefar Sava (IL); YEVGENIY KIVEISHA, Bnei Aish (IL)

(21) Appl. No.: 14/577,951

(22) Filed: Dec. 19, 2014

(51) Int. Cl. G02B 27/01; G09G 3/00; G06F 3/02; G06F 3/16; G06F 3/01

(52) U.S. Cl. CPC G02B 27/0172; G02B 27/0101; G06F 3/16; G06F 3/017; G06F 3/02; G09G 3/001; G02B 2027/0138; G02B 2027/014; G09G 2360/14

(57) ABSTRACT

A mechanism is described for dynamically facilitating improved viewing capabilities for glass displays according to one embodiment. A method of embodiments, as described herein, includes detecting light conditions in relation to a computing device including wearable glasses having a smart glass, where detecting of the light conditions may include detecting a change in the light conditions. The method may further include evaluating influences of the change in the light conditions, and facilitating turning on or off of the smart glass based on the change in the light conditions.

### FIELD

Embodiments described herein generally relate to computers. More particularly, embodiments relate to dynamically facilitating improved viewing capabilities for glass displays.

### BACKGROUND

With the growth of mobile computing devices, wearable devices (e.g., smart windows, head-mounted displays, such as wearable glasses) are also gaining popularity and noticeable traction in becoming a mainstream technology. Conventional glass displays, such as those of wearable devices, are limited with respect to their display and see-through capabilities which, in turn, severely lowers the user experience. For example, today's glass displays make it difficult for users to view the details on the screen in a clear matter, forcing the users to look for darker stops to block the outside lights.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a dynamic glass viewing mechanism according to one embodiment.

FIG. 2A illustrates a dynamic glass viewing mechanism according to one embodiment.

FIG. 2B illustrates a computing device having a smart glass according to one embodiment.

FIG. 2C illustrates an unassembled view of a computing device having a smart glass according to one embodiment.

FIG. 2D illustrates a default scene where a smart glass is turned off according to one embodiment.

FIG. 2E illustrates an enhanced scene where a smart glass is turned on according to one embodiment.

FIG. 2F illustrates a pair of glasses having a clear lens and a foggy lens according to one embodiment.

FIG. 3 illustrates a method for facilitating improved viewing capabilities for glass displays according to one embodiment.

FIG. 4 illustrates computer system suitable for implementing embodiments of the present disclosure according to one embodiment.

FIG. 5 illustrates computer environment suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for better and clearer viewing capabilities for glass displays. As aforementioned, conventional glass displays, such as those of wearable devices, are limited their display capabilities which severely limit the user's ability to view details in bright backgrounds.

Embodiments provide for adding another layer of glass to glass displays using any number and type of technologies to facilitate better control over glass transparency which may be activated automatically or manually based on any number and type of factors as will be further described in this document.

It is contemplated and will be discussed throughout this document that any number and type of contextual and/or environmental changes may influence the user's vision through the wearable device, such as wearable glasses. For example, in one embodiment, in wearable devices like head-mounted displays, such as wearable glasses, etc., the visibility of the display is a rather important factor to the user experiences to the devices successes which is critically influenced by the contextual and/or environment changes, such as changes in brightness levels, light levels, surroundings, etc. For example, when used in day light or in close proximity of a light source, such as outdoors when the sun is out, in bright background, or even scenes which can negatively interfere with or influence the colors, layouts, etc., that are being displayed on the display screen of the user's wearable device such that making it difficult for the user to view contents on the display screen when the light, background, etc., is too bright. It can be difficult to see the details on the display screen in a clear manner, forcing the user to look for a darker scene or background for better which has positive influence in allowing the user to properly view the display screen.

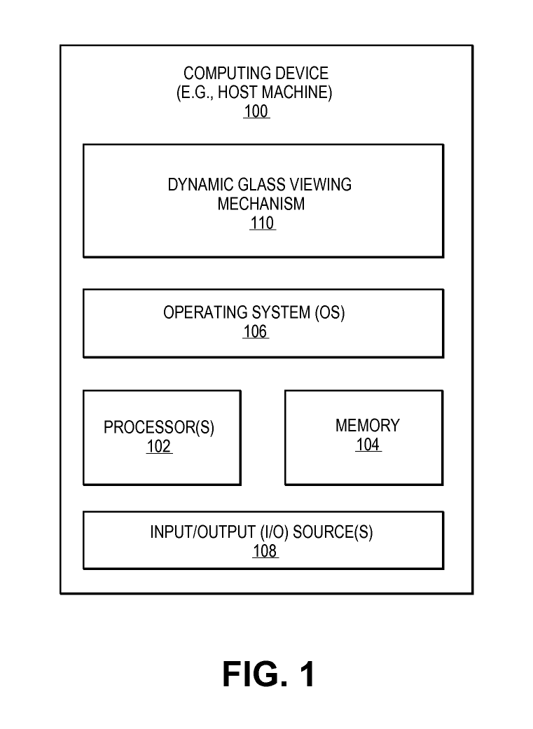

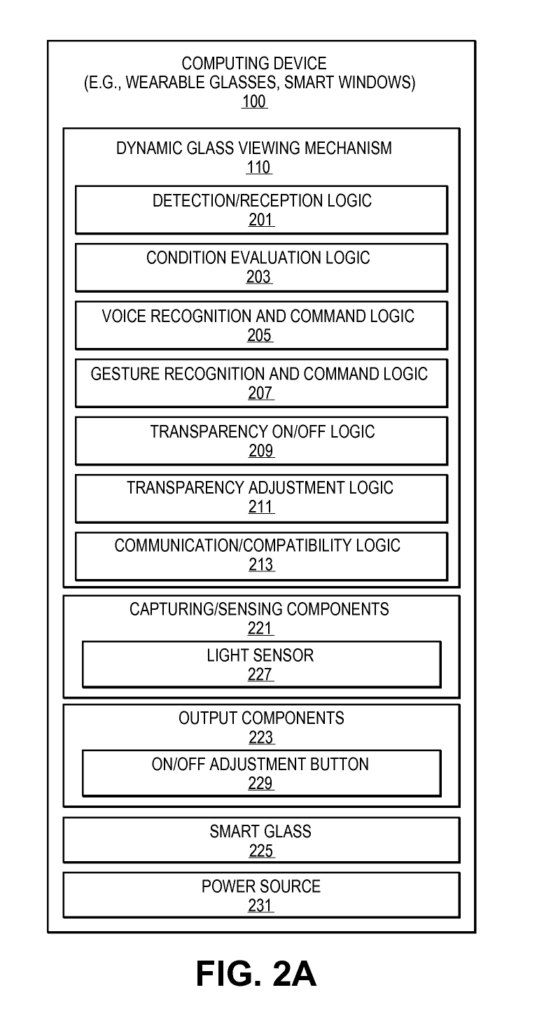

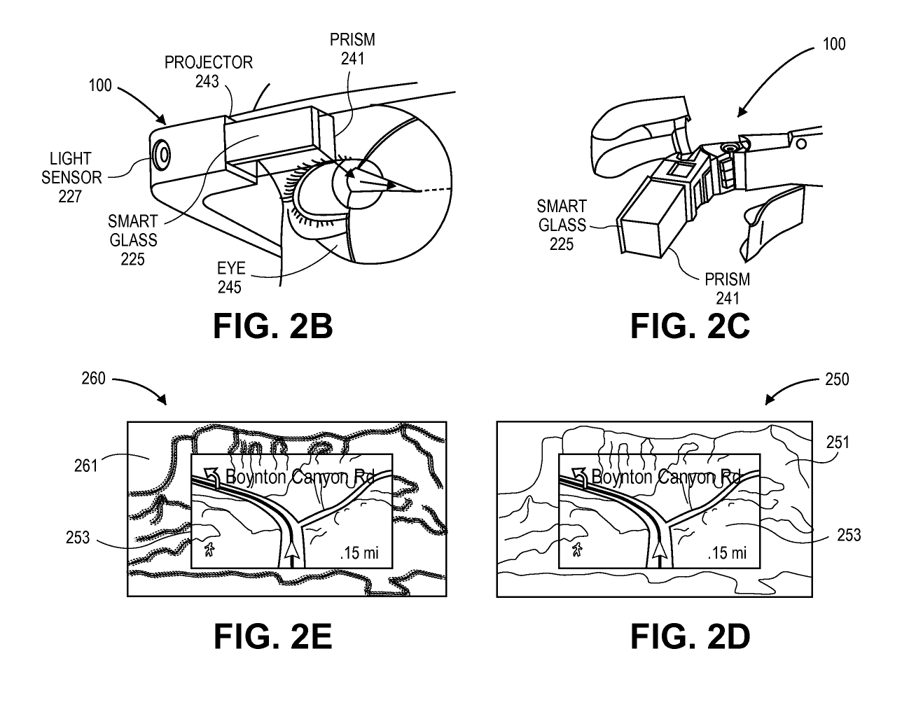

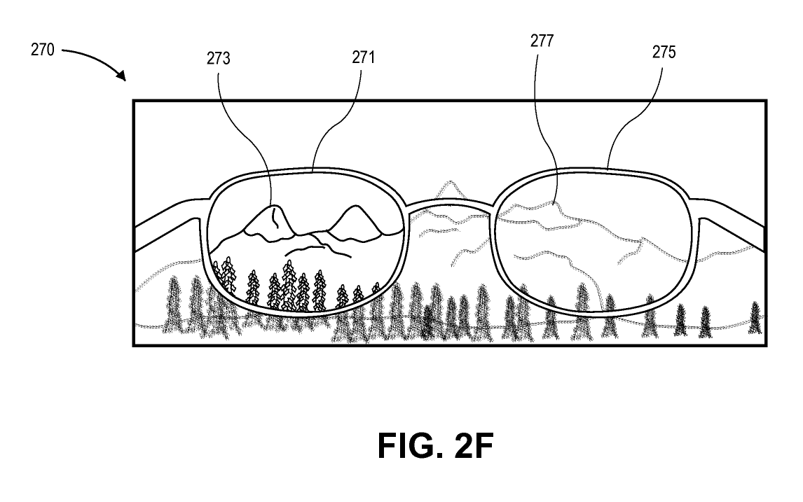

FIG. 1 illustrates a computing device 100 employing a dynamic glass viewing mechanism 110 according to one embodiment. Computing device 100 serves as a host machine for hosting dynamic glass viewing mechanism (“glass mechanism”) 110 that includes any number and type of components, as illustrated in FIG. 2, to efficiently employ one or more components to dynamically facilitate improved viewing for glass displays will be further described throughout this document.

Computing device 100 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, smart windshields, smart windows, head-mounted displays (HMDs) (e.g., optical head-mounted display (e.g., wearable glasses (such as Google® Glass™, etc.), head-mounted binoculars, gaming displays, military headwear, etc.), and other wearable devices (e.g., smartwatches, bracelets, smartcards, jewelry, clothing items, etc.), etc.

It is contemplated and to be noted that embodiments are not limited to computing device 100 and that embodiments may be applied to and used with any form or type glass that is used for viewing purposes, such as smart windshields, smart windows (e.g., smart window by Samsung®, etc.), and/or the like. Similarly, it is contemplated and to be noted that embodiments are not limited to any particular type of computing device and that embodiments may be applied and used with any number and type of computing devices; however, throughout this document, the focus of the discussion may remain on wearable devices, such as wearable glasses, etc., which are used as examples for brevity, clarity, and ease of understanding.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a group of individuals using or having access to computing device 100.

FIG. 2A illustrates a dynamic glass viewing mechanism 110 according to one embodiment. In one embodiment, glass mechanism 110 may include any number and type of components, such as (without limitation): detection/reception logic 201; condition evaluation logic (“condition logic”) 203; voice recognition and command logic (“voice logic”) 205; and gesture recognition and command logic (“gesture logic”) 207; transparency on/off logic (“on/off logic”) 209; transparency adjustment logic (“adjustment logic”) 211; and communication/compatibility logic 213. Computing device 100 (e.g., wearable glasses, smart window, etc.) may further include any number and type of other components, such as capturing/sensing components 221 (including, for example, light sensor 227, cameras, microphones, etc.), output components 223 (including, for example, on/off/adjustment button 229, display glass screen, etc.), smart glass 225, power source 231, etc.

Capturing/sensing components 221 may further include any number and type of capturing/sensing devices, such as one or more sending and/or capturing devices (e.g., cameras, microphones, biometric sensors, chemical detectors, signal detectors, wave detectors, force sensors (e.g., accelerometers), illuminators, etc.) that may be used for capturing any amount and type of visual data, such as images (e.g., photos, videos, movies, audio/video streams, etc.), and non-visual data, such as audio streams (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), environmental/weather conditions, maps, etc. It is contemplated that “sensor” and “detector” may be referenced interchangeably throughout this document. It is further contemplated that one or more capturing/sensing components 221 may further include one or more supporting or supplemental devices for capturing and/or sensing of data, such as illuminators (e.g., infrared (IR) illuminator), light fixtures, generators, sound blockers, etc.

It is further contemplated that in one embodiment, capturing/sensing components 221 may further include any number and type of sensing devices or sensors (e.g., linear accelerometer) for sensing or detecting any number and type of contexts (e.g., estimating horizon, linear acceleration, etc., relating to a mobile computing device, etc.). For example, capturing/sensing components 221 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); gravity gradiometers to study and measure variations in gravitation acceleration due to gravity, etc.

For example, capturing/sensing components 221 may further include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.), biometric sensors (such as to detect fingerprints, etc.), calendar maintenance and reading device), etc.; global positioning system (GPS) sensors; resource requestor; and trusted execution environment (TEE) logic. TEE logic may be employed separately or be part of resource requestor and/or an I/O subsystem, etc.

Computing device 100 may further include one or more output components 223 to remain in communication with one or more capturing/sensing components 221 and one or more components of glass mechanism 110 to facilitate displaying of images, playing or visualization of sounds, displaying visualization of fingerprints, presenting visualization of touch, smell, and/or other sense-related experiences, etc. For example and in one embodiment, output components 223 may include (without limitation) one or more of light sources, display devices or screens, audio speakers, bone conducting speakers, olfactory or smell visual and/or non/visual presentation devices, haptic or touch visual and/or non-visual presentation devices, animation display devices, biometric display devices, X-ray display devices, etc.

Computing device 100 may be in communication with one or more repositories or databases over one or more networks, where any amount and type of data (e.g., real-time data, historical contents, metadata, resources, policies, criteria, rules and regulations, upgrades, etc.) may be stored and maintained. Similarly, computing device 100 may be in communication with any number and type of other computing devices, such as HMDs, wearable devices, smart windows, mobile computers (e.g., smartphone, a tablet computer, etc.), desktop computers, laptop computers, etc., over one or more networks (e.g., cloud network, the Internet, intranet, Internet of Things (“IoT”), proximity network, Bluetooth, etc.).

In the illustrated embodiment, computing device 100 is shown as hosting glass mechanism 110; however, it is contemplated that embodiments are not limited as such and that in another embodiment, glass mechanism 110 may be entirely or partially hosted by multiple or a combination of computing devices; however, throughout this document, for the sake of brevity, clarity, and ease of understanding, glass mechanism 100 is shown as being hosted by computing device 100.

It is contemplated that computing device 100 may include one or more software applications (e.g., device applications, hardware components applications, business/social application, websites, etc.) in communication with glass mechanism 110, where a software application may offer one or more user interfaces (e.g., web user interface (WUI), graphical user interface (GUI), touchscreen, etc.) to work with and/or facilitate one or more operations or functionalities of glass mechanism 110.

As aforementioned, glass-based devices, such as wearable glasses, smart windows, etc., are not well-equipped or smart enough to properly respond to the interference or influence caused by the changing lighting conditions or various levels of brightness, such as indoor lighting, outdoor lighting, etc. For example, when a glass-based device is used in challenging light conditions, such as daylight or in front of a powerful light source (e.g., sun), the light can make for a very bright background on the display screen (e.g., glass display screen) which can severely disturb and negatively influence the colors and the layout, making it very difficult for the user to view the contents on the screen. This can force the user to look for a darker scene or background just to be able to be properly view the screen, since a darker background can have a positive influence on the contents of the display screen in allowing the user to view the contents on the display screen of computing device 100.

In one embodiment, smart glass 225 may be added to or incorporated into computing device 100 to facilitate controlling of glass transparency associated with smart glass 225 which may be activated manually or automatically and dynamically based on, for example, environmental needs, changing (natural or artificial) lighting conditions, etc., as will be further described in this document. For example, in case of computing device 100 being a wearable device, such as wearable glasses, smart glass 225 may be inserted as a layer of glass in parallel with and next to a prism as further illustrated with respect to FIG. 2B. Similarly, in case of computing device 100 being a smart window, a layer of smart glass 225 may be employed to achieve controlling of glass transparency. In some embodiments, multiple layers and sizes of smart glass 225 may be incorporated into computing device 100. In some embodiments, smart glass 225 may be of any size from being very small to rather large based on any number and type of techniques or technologies, such as (without limitation) electrochromic, photochromic, thermochromic, or suspended particles, etc. It is contemplated and to be noted that embodiments are not limited to smart glass 225 being small or large, a single layer or a block of layers, or depending on any particular type or form of technology, etc.

In one embodiment, detection/reception logic 201 may detect environmental deviations (also referred to as “surrounding deviations” or “surrounding changes”) in lighting conditions which may be based on natural deviations (e.g., sun breaking out of clouds, starting to rain, approaching dawn or dusk, etc.), artificial deviations (e.g., the user waking out from a dark room into the bright outdoors, turning on and off of lights, opening and closing of doors/windows, etc.), or any combination thereof. Once one or more surrounding deviation in lighting conditions are detected by detection/reception logic 201, any information relating to these surrounding deviations is then provided to condition logic 203 for further processing.

In another embodiment and optionally, light sensor 227 of capturing/sensing components 221 may be employed to detect and determine the light conditions and used by computing device 100 and upon detecting the light conditions, light sensor 227 may automatically trigger on/off logic 209 to turn smart glass 225 on/off and/or instruct adjustment logic 211 to automatically and dynamically adjust the current transparency level of smart glass 225.

In one embodiment, condition logic 203 may then evaluate the information relating to the change or deviation to determine whether transparency of smart glass 225 needs to be adjusted for better viewing of contents on a display screen (e.g., glass screen) of output components 223 of computing device 100. In some embodiments, while evaluating the information, condition logic 203 may take into consideration any number and type of predefined thresholds, predetermined criteria, policies, user preferences, voice instructions, gestures, etc., to reach its decision regarding whether the transparency of smart glass 225 is to be adjusted. For example, predefined user preferences may dictate glass transparency levels to be adjusted based on certain hours (such as 8 AM-5 PM, evenings, sleep hours, etc.), particular locations (e.g., office, in-flight, outdoors, etc.), etc.

Moreover, in one embodiment, in addition to any predefined user preferences, real-time user directions may be received via voice logic 205, gesture logic 207, on/off button 229, etc., and these real-time directions may be incorporated into the process and, in some embodiments, given priority or overriding powers over predefined user preferences and evaluation results of condition logic 203, etc., as will be further described with reference to voice logic 205, gesture logic 207, and on/off button 229.

Referring back to condition logic 203, upon evaluation of the information relating to changes in lighting conditions, if condition logic 203 determines that the surrounding deviations are significant enough (such as when compared to a predefined threshold of light) to cause viewing ease or difficulties for the user, condition logic 203 may then communicate its instructions to adjustment logic 211 to facilitate automatic and dynamic adjustments to the current transparency levels of smart glass 225 based on the instructions.

In one embodiment, upon receiving the instructions, adjustment logic 211 may automatically and dynamically adjust transparency levels of smart glass 225. For example, in one embodiment, power source 231 may be triggered by adjustment logic 221 to supply additional power to supply light to smart glass 225 to reduce its transparency (such as making smart glass 225 foggier, dirtier, and/or darker) so it may serve to provide a darker background to the glass display screen being viewed by the user so that the contents on the screen may be better or more clearly viewed. In another embodiment, power source 231 may be triggered by adjustment logic 221 to supply less power to smart glass 225 in order to increase the transparency (such as reducing the fogginess) of smart glass 225 as the surrounding conditions may have become darker, reducing the need for a dark background for better viewing of the contents.

In one embodiment, full transparency or the turning off of smart glass 225 may be regarded as a default position of smart glass 225 so that any unnecessary consumption of power may be prevented. For example, to avoid unnecessary power consumption on computing device 100, by default, smart glass 225 may be kept off or fully transparent until on/off logic 209 receives instructions to turn the transparency off and subsequently, adjust it to a particular level. In this case, merely a small amount to power is supplied from power source 231 to turn smart glass 255 foggier or less transparent to provide the necessary darkness or lower brightness in the background to allow the user to conveniently view the contents on the screen of computing device 100. Although, by default, smart glass 225 is kept transparent to avoid any unnecessary power consumption, it is contemplated that even when power is supplied, the amount of power is significantly low while using the same power source 231 that is used by computing device 100 in order to ensure a very low, such as nearly negligible, consumption of power and without having to require any additional power sources or hardware.

As aforementioned, in some embodiments, the user may provide real-time directions via voice and/or gestures to directly influence the transparency levels of smart glass 225. For example, in one embodiment, the user may simply place one or more predefined voice commands (e.g., “on”, “off”, “lower transparency”, “need transparency”, “need screen”, “delete screen”, “too bright”, “two levels up”, “one level down”, and/or the like) which may be detected by a microphone of capturing/sensing components 221 and then receive by voice logic 205. Upon receiving a predefined voice command, voice logic 205 may translate the voice command and communicate any corresponding instructions to on/off logic 209 and/or adjustment logic 211 so that they may automatically perform their tasks based on the instructions representing the voice command.

As with the voice command, in some embodiments, the user may choose to provide real-time directions using one or more gestures that are detected, for example, by a camera of capturing/sensing components 221 and then received by gesture logic 207 for further processing. In one embodiment, a gesture may be predefined such that when it is received by gesture logic 207, it is translated by gesture logic 207 and any corresponding instructions may then be communicated on to on/off logic 209 and/or adjustment logic 211 so they may automatically perform their tasks based on the instructions representing the gesture.

Similarly, in some embodiments, on/off/adjustment button 229 of output components 223 may be used by the user to choose to manually turn on/off the transparency level of smart glass 225 or adjust the current transparency to one or more higher/lower levels, as desired or necessitated.

Communication/compatibility logic 213 may be used to facilitate dynamic communication and compatibility between computing device 100 and any number and type of other computing devices (such as wearable computing devices, mobile computing devices, desktop computers, server computing devices, etc.), processing devices (e.g., central processing unit (CPU), graphics processing unit (GPU), etc.), capturing/sensing components 221 (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, databases and/or data sources (such as data storage devices, hard drives, solid-state drives, hard disks, memory cards or devices, memory circuits, etc.), networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and the like, may be referenced interchangeably and include, by way of example, software, hardware, and/or any combination of software and hardware, such as firmware. Further, any use of a particular brand, word, term, phrase, name, and/or acronym, such as “wearable device”, “Head-Mounted Display” or “HDM”, “wearable glasses”, “smart window”, “smart glass”, “transparency” or “transparency level”, etc., should not be read to limit embodiments to software or devices that carry that label in products or in literature external to this document.

It is contemplated that any number and type of components may be added to and/or removed from glass mechanism 110 to facilitate various embodiments including adding, removing, and/or enhancing certain features. For brevity, clarity, and ease of understanding of glass mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 2B illustrates a smart glass 225 employed at a computing device 100 according to one embodiment. For brevity, many of the details discussed with reference to FIGS. 1 and 2A may not be discussed or repeated hereafter. As illustrated, computing device 100 is shown to include a pair of wearable glasses which when placed on a person's head is in front of human eye 245. In the illustrated embodiment, smart glass 225 is placed on prism 241, where prism 241 is on the inside or back facing eye 245, while smart glass 225 is placed on the outside or front portion of prism 241 and wearable glasses 100. In one embodiment, the placement of smart glass 225 allows it to serve as an additional layer of glass over prism 241 as an intermediate layer between prism 241 and the outside conditions. As aforementioned, in some embodiments, smart glass 225 may be a block of glass or multiple layers of glass. The illustrated embodiment further illustrates light sensor 227 and projector 243 as part of wearable glasses 100.

As previously discussed with reference to FIG. 2A, transparency levels of smart glass 225 may be turned on or off and adjusted according to surrounding conditions and as requested by the user via voice and/or gesture commands. Further, as previously discussed, in one embodiment, light sensor 227 may be used to detect or sense the surrounding lighting conditions.

Now referring to FIG. 2C, it illustrates an unassembled view of computing device 100 having a smart glass 225 according to one embodiment. As discussed with reference to FIG. 2B, computing device 100 is shown to include a pair of wearable glasses including prism 241 and, in one embodiment, a layer of smart glass 225 which is associated with prism 241.

FIG. 2D illustrates a default scene 250 according to one embodiment. Scene 250 is regarded as a default scene which is achieved in the absence of smart glass 225 of FIG. 2A or, in some cases, it may be regarded as a default scene or position where smart glass 225 is turned off. As illustrated, in scene 250, background 251, by default, is kept as normally bright, having an influence (e.g., negative influence) in making it very difficult for the user to view or decipher map 253 being displayed in the foreground of the glass display screen.

In contrast to FIG. 2D, FIG. 2E illustrates an enhanced scene 260 which is achieved when smart glass 225 of FIG. 2A is turned on and the transparency level is correspondingly adjusted according to one embodiment. In one embodiment and as illustrated, turning on smart glass 225 facilitates background 261 to be fogged, dimmed, or darkened, etc., having an influence (e.g., positive influence) in making the foreground having map 253 relatively clearer and more prominent which, in turn, makes it easier for the user to view and decipher map 253 being displayed in the foreground of the glass display screen.

FIG. 2F illustrates a pair of glasses 270 having a clear lens 271 and a foggy lens 275 according to one embodiment. As illustrated, left frame 271 of glasses 270 holds clear lens 273 due to smart glass 225 of FIG. 2A being turned off. However, in one embodiment and as described with reference to FIG. 2A, smart glass 225 may be turned on, automatically or manually, which dynamically and correspondingly adjusts the transparency level, resulting in a softer and/or darker background, as illustrated here, such as with respect to foggy lens 277 of right frame 275, allowing the user a better view of any text, graphics, etc., in the foreground of lens 277 while ignoring the background as hazy or foggy.

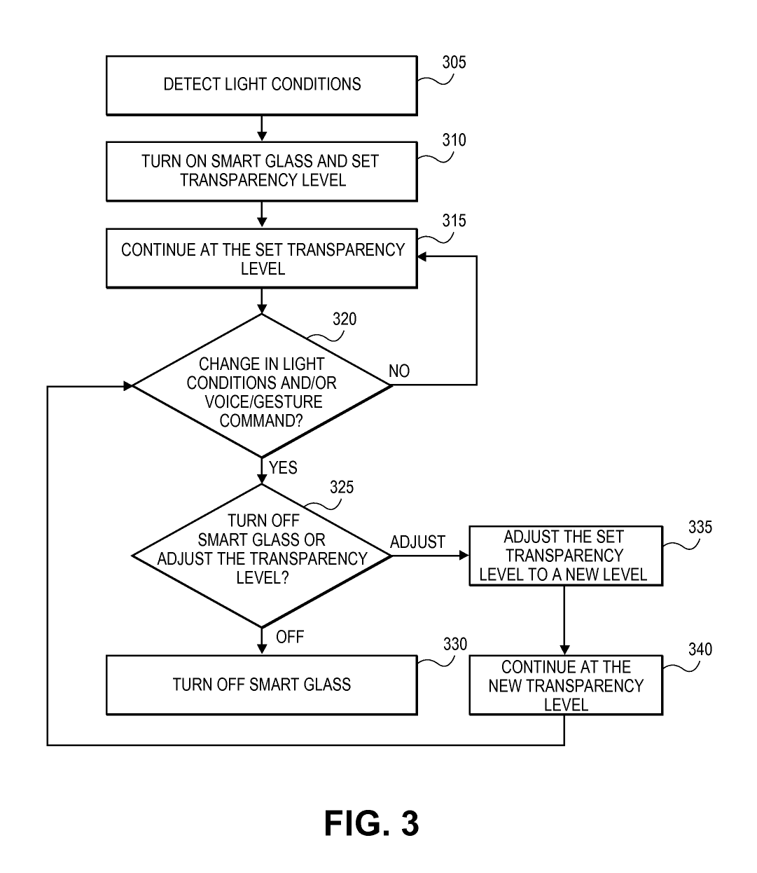

FIG. 3 illustrates a method 300 for facilitating improved viewing capabilities for glass displays according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by glass mechanism 110 of FIGS. 1-2F. The processes of method 300 are illustrated in linear sequences for brevity and clarity in presentation; however, it is contemplated that any number of them can be performed in parallel, asynchronously, or in different orders. For brevity, many of the details discussed with reference to FIGS. 1 and 2A-F may not be discussed or repeated hereafter.

Method 300 may begin with block 305 with detection of surrounding light conditions. At block 310, a smart glass at a computing device (e.g., wearable glasses, smart window, etc.) may be turned on and any transparency associated with the smart glass (and thus with the computing device) may be dynamically and correspondingly adjusted and set to an appropriate level. For example, surrounding light conditions may change such that it becomes difficult for the user of the wearable glasses to view or read any text and/or graphics being displayed on the screen of the wearable glasses. In one embodiment, in turning on the smart glass and adjusting the transparency levels associated with the smart glass, proper fogging or darkening of the background of the screen (e.g., display glass screen) may be facilitated such that the text and/or graphics being displayed in the foreground of the screen may be clearly viewed by the user.

At block 315, upon reaching the appropriately adjusted the transparency associated with the smart glass, the process may continue with the appropriate transparency level. As aforementioned, in some embodiments, having a bright light or background, etc., can influence the user's view of the display screen, making it difficult for the user to view the contents of the display screen of the computing device, such as wearable device. For example, the sun outdoors or a bright light indoors, etc., may cause certain light conditions that can influence (e.g., negatively influence) the view of the display screen, making it difficult for the user to view any of the contents of the display screen of the computing device, such as a wearable device. In contrast, having fogged, dull, or darker background or lower lights, etc., whether outdoors or indoors, may cause certain light conditions that can influence (e.g., positively influence) the view of the display screen, making it easier for the user to view any of the contents of the display screen of computing device, such as a wearable device.

At decision block 320, a determination is made as to whether a change in the surrounding light conditions is detected or whether a user has placed a voice command and/or a gesture command to alter the current transparency level. If not, the process may continue at the current transparency level at block 315. If yes, in one embodiment, at block 320, another determination is made as to whether the smart glass be turned off or the current transparency level is to be adjusted. If the smart glass needs to be turned off, such as based on a change in the surrounding light conditions or in response to the voice command and/or the gesture command, the smart glass is turned off at block 330. However, if the current transparency level is to be adjusted, in one embodiment, the current transparency level associated with the smart device is dynamically adjusted to a new appropriate level at block 335. At block 340, the process continues with the new transparency level and further, the process continues with decision block 320.

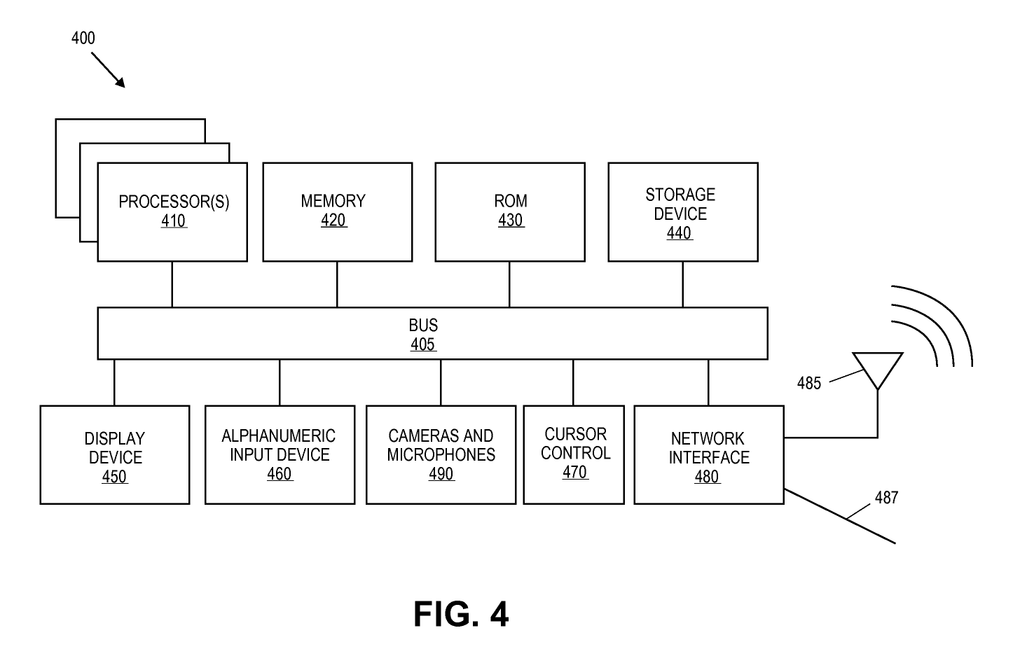

FIG. 4 illustrates an embodiment of a computing system 400 capable of supporting the operations discussed above. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 400 may be the same as or similar to or include computing devices 100 described in reference to FIG. 1.

Computing system 400 includes bus 405 (or, for example, a link, an interconnect, or another type of communication device or interface to communicate information) and processor 410 coupled to bus 405 that may process information. While computing system 400 is illustrated with a single processor, it may include multiple processors and/or co-processors, such as one or more of central processors, image signal processors, graphics processors, and vision processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

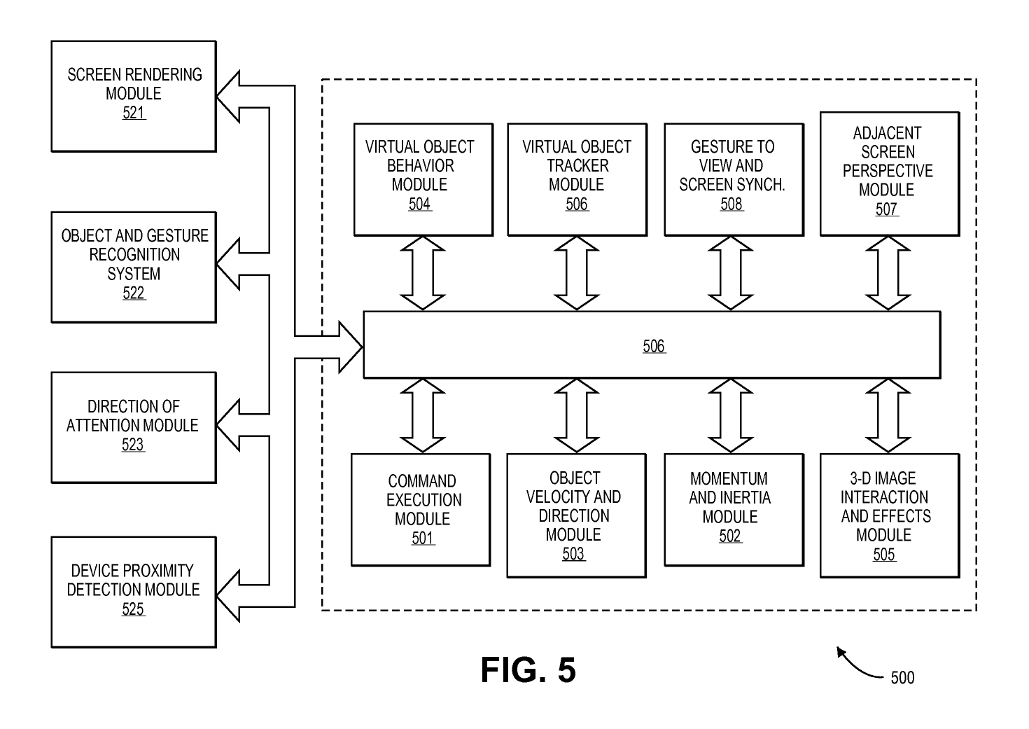

FIG. 5 illustrates an embodiment of a computing environment 500 capable of supporting the operations discussed above. The modules and systems can be implemented in a variety of different hardware architectures and form factors including that shown in FIG. 9.

The Command Execution Module 501 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 521 draws objects on the one or more multiple screens for the user to see. It can be adapted to receive the data from the Virtual Object Behavior Module 504, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 507, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 522 may be adapted to recognize and track hand and harm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without benefit of a touch surface.

The Direction of Attention Module 523 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 522 to ensure that the gestures or commands are associated with the appropriate library for the active display. Similarly, if the user is looking away from all of the screens, then commands can be ignored.

The Device Proximity Detection Module 525 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 522. For a display device, it may be considered by the Adjacent Screen Perspective Module 507.

The Virtual Object Behavior Module 504 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 506 on the other hand may be adapted to track where a virtual object should be located in three dimensional space in a vicinity of an display, and which body part of the user is holding the virtual object, based on input from the Object and Gesture Recognition Module. The Virtual Object Tracker Module 506 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 508, receives the selection of the view and screen or both from the Direction of Attention Module 523 and, in some cases, voice commands to determine which view is the active view and which screen is the active screen. It then causes the relevant gesture library to be loaded for the Object and Gesture Recognition System 522. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 507, which may include or be coupled to the Device Proximity Detection Module 525, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 507 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 503 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 502 can use image motion, image size, and angle changes of objects in the image plane or in a three-dimensional space to estimate the velocity and direction of objects in the space or on a display. The Momentum and Inertia Module is coupled to the Object and Gesture Recognition System 522 to estimate the velocity of gestures performed by hands, fingers, and other body parts and then to apply those estimates to determine momentum and velocities to virtual objects that are to be affected by the gesture.

The 3D Image Interaction and Effects Module 505 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to dynamically facilitate improved viewing capabilities for glass displays on computing devices, comprising: detection/reception logic to detect light conditions in relation to a computing device including wearable glasses, wherein the wearable glasses include a smart glass, wherein the detection/reception logic is further to detect a change in the light conditions; condition evaluation logic to evaluate influences of the change in the light conditions; and transparency on/off logic to facilitate, based on the change in the light conditions, turning on or off of the smart glass.

Example 2 includes the subject matter of Example 1, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

Example 3 includes the subject matter of Example 1, further comprising transparency adjustment logic to facilitate an adjustment to the transparency based on the evaluated influence, wherein the influence includes causing difficulty or ease in viewing contents via a display screen of the computing device, wherein the display screen includes a transparent glass display screen.

Example 4 includes the subject matter of Example 3, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

Example 5 includes the subject matter of Example 1, further comprising voice recognition and command logic to detect, via a first capturing/sensing component, a voice command from a user of the computing device to facilitate a voice command-based adjustment to the transparency of the smart glass, wherein the first capturing/sensing component includes a microphone.

Example 6 includes the subject matter of Example 1, further comprising gesture recognition and command logic to detect, via a second capturing/sensing component, a gesture command from a user of the computing device to facilitate a gesture command-based adjustment to the transparency of the smart glass, wherein the second capturing/sensing component includes a camera.

Example 7 includes the subject matter of Example 1, further comprising an on/off adjustment button of output components of the computing device, wherein the on/off adjustment button to facilitate a manual adjustment of the transparency of the smart glass.

Example 8 includes the subject matter of Example 1, wherein the light conditions are detected by the detection/reception logic via a third capturing/sensing component, wherein the third capturing/sensing component includes a light sensor, wherein the smart glass is powered via a power source of the computing device.

Some embodiments pertain to Example 9 that includes a method for dynamically facilitating improved viewing capabilities for glass displays on computing devices, comprising: detecting light conditions in relation to a computing device including wearable glasses, wherein the wearable glasses include a smart glass, wherein detecting further includes detecting a change in the light conditions; evaluating influences of the change in the light conditions; and facilitating, based on the change in the light conditions, turning on or off of the smart glass.

Example 10 includes the subject matter of Example 9, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

Example 11 includes the subject matter of Example 9, further comprising facilitating an adjustment to the transparency based on the evaluated influence, wherein the influence includes causing difficulty or ease in viewing contents via a display screen of the computing device, wherein the display screen includes a transparent glass display screen.

Example 12 includes the subject matter of Example 11, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

Example 13 includes the subject matter of Example 9, further comprising detecting, via a first capturing/sensing component, a voice command from a user of the computing device to facilitate a voice command-based adjustment to the transparency of the smart glass, wherein the first capturing/sensing component includes a microphone.

Example 14 includes the subject matter of Example 9, further comprising detecting, via a second capturing/sensing component, a gesture command from a user of the computing device to facilitate a gesture command-based adjustment to the transparency of the smart glass, wherein the second capturing/sensing component includes a camera.

Example 15 includes the subject matter of Example 9, further comprising facilitating a manual adjustment of the transparency of the smart glass, wherein the manual adjustment is facilitated via an on/off adjustment button of output components of the computing device.

Example 16 includes the subject matter of Example 9, wherein the light conditions are detected via a third capturing/sensing component, wherein the third capturing/sensing component includes a light sensor, wherein the smart glass is powered via a power source of the computing device.

Example 17 includes at least one machine-readable medium comprising a plurality of instructions, when executed on a computing device, to implement or perform a method or realize an apparatus as claimed in any preceding claims.

Example 18 includes at least one non-transitory or tangible machine-readable medium comprising a plurality of instructions, when executed on a computing device, to implement or perform a method or realize an apparatus as claimed in any preceding claims.

Example 19 includes a system comprising a mechanism to implement or perform a method or realize an apparatus as claimed in any preceding claims.

Example 20 includes an apparatus comprising means to perform a method as claimed in any preceding claims.

Example 21 includes a computing device arranged to implement or perform a method or realize an apparatus as claimed in any preceding claims.

Example 22 includes a communications device arranged to implement or perform a method or realize an apparatus as claimed in any preceding claims.

Some embodiments pertain to Example 23 includes a system comprising a storage device having instructions, and a processor to execute the instructions to facilitate a mechanism to perform one or more operations comprising: detecting light conditions in relation to a computing device including wearable glasses, wherein the wearable glasses include a smart glass, wherein detecting further includes detecting a change in the light conditions; evaluating influences of the change in the light conditions; and facilitating, based on the change in the light conditions, turning on or off of the smart glass.

Example 24 includes the subject matter of Example 23, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

Example 25 includes the subject matter of Example 23, wherein the one or more operations further comprise facilitating an adjustment to the transparency based on the evaluated influence, wherein the influence includes causing difficulty or ease in viewing contents via a display screen of the computing device, wherein the display screen includes a transparent glass display screen.

Example 26 includes the subject matter of Example 25, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

Example 27 includes the subject matter of Example 23, wherein the one or more operations further comprise detecting, via a first capturing/sensing component, a voice command from a user of the computing device to facilitate a voice command-based adjustment to the transparency of the smart glass, wherein the first capturing/sensing component includes a microphone.

Example 28 includes the subject matter of Example 23, wherein the one or more operations further comprise detecting, via a second capturing/sensing component, a gesture command from a user of the computing device to facilitate a gesture command-based adjustment to the transparency of the smart glass, wherein the second capturing/sensing component includes a camera.

Example 29 includes the subject matter of Example 23, wherein the one or more operations further comprise facilitating a manual adjustment of the transparency of the smart glass, wherein the manual adjustment is facilitated via an on/off adjustment button of output components of the computing device.

Example 30 includes the subject matter of Example 23, wherein the light conditions are detected via a third capturing/sensing component, wherein the third capturing/sensing component includes a light sensor, wherein the smart glass is powered via a power source of the computing device.

Some embodiments pertain to Example 31 includes an apparatus comprising: means for detecting light conditions in relation to a computing device including wearable glasses, wherein the wearable glasses include a smart glass, wherein means for detecting further includes means for detecting a change in the light conditions; means for evaluating influences of the change in the light conditions; and means for facilitating, based on the change in the light conditions, turning on or off of the smart glass.

Example 32 includes the subject matter of Example 31, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

Example 33 includes the subject matter of Example 31, further comprising means for facilitating an adjustment to the transparency based on the evaluated influence, wherein the influence includes causing difficulty or ease in viewing contents via a display screen of the computing device, wherein the display screen includes a transparent glass display screen.

Example 34 includes the subject matter of Example 33, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

Example 35 includes the subject matter of Example 31, further comprising means for detecting, via a first capturing/sensing component, a voice command from a user of the computing device to facilitate a voice command-based adjustment to the transparency of the smart glass, wherein the first capturing/sensing component includes a microphone.

Example 36 includes the subject matter of Example 31, further comprising means for detecting, via a second capturing/sensing component, a gesture command from a user of the computing device to facilitate a gesture command-based adjustment to the transparency of the smart glass, wherein the second capturing/sensing component includes a camera.

Example 37 includes the subject matter of Example 31, further comprising means for facilitating a manual adjustment of the transparency of the smart glass, wherein the manual adjustment is facilitated via an on/off adjustment button of output components of the computing device.

Example 38 includes the subject matter of Example 31, wherein the light conditions are detected via a third capturing/sensing component, wherein the third capturing/sensing component includes a light sensor, wherein the smart glass is powered via a power source of the computing device.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/reception logic to detect light conditions in relation to a computing device including wearable glasses, wherein the wearable glasses include a smart glass, wherein the detection/reception logic is further to detect a change in the light conditions;
condition evaluation logic to evaluate influences of the change in the light conditions; and
transparency on/off logic to facilitate, based on the change in the light conditions, turning on or off of the smart glass.

2. The apparatus of claim 1, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

3. The apparatus of claim 1, further comprising transparency adjustment logic to facilitate an adjustment to the transparency based on the evaluated influence, wherein the influence includes causing difficulty or ease in viewing contents via a display screen of the computing device, wherein the display screen includes a transparent glass display screen.

4. The apparatus of claim 3, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

5. The apparatus of claim 1, further comprising voice recognition and command logic to detect, via a first capturing/sensing component, a voice command from a user of the computing device to facilitate a voice command-based adjustment to the transparency of the smart glass, wherein the first capturing/sensing component includes a microphone.

6. The apparatus of claim 1, further comprising gesture recognition and command logic to detect, via a second capturing/sensing component, a gesture command from a user of the computing device to facilitate a gesture command-based adjustment to the transparency of the smart glass, wherein the second capturing/sensing component includes a camera.

7. The apparatus of claim 1, further comprising an on/off adjustment button of output components of the computing device, wherein the on/off adjustment button to facilitate a manual adjustment of the transparency of the smart glass.

8. The apparatus of claim 1, wherein the light conditions are detected by the detection/reception logic via a third capturing/sensing component, wherein the third capturing/sensing component includes a light sensor, wherein the smart glass is powered via a power source of the computing device.

9. A method comprising:
detecting light conditions in relation to a computing device including wearable glasses, wherein the wearable glasses include a smart glass, wherein detecting further includes detecting a change in the light conditions;
evaluating influences of the change in the light conditions; and
facilitating, based on the change in the light conditions, turning on or off of the smart glass.

10. The method of claim 9, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

11. The method of claim 9, further comprising facilitating an adjustment to the transparency based on the evaluated influence, wherein the influence includes causing difficulty or ease in viewing contents via a display screen of the computing device, wherein the display screen includes a transparent glass display screen.

12. The method of claim 11, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

13. The method of claim 9, further comprising detecting, via a first capturing/sensing component, a voice command from a user of the computing device to facilitate a voice command-based adjustment to the transparency of the smart glass, wherein the first capturing/sensing component includes a microphone.

14. The method of claim 9, further comprising detecting, via a second capturing/sensing component, a gesture command from a user of the computing device to facilitate a gesture command-based adjustment to the transparency of the smart glass, wherein the second capturing/sensing component includes a camera.

15. The method of claim 9, further comprising facilitating a manual adjustment of the transparency of the smart glass, wherein the manual adjustment is facilitated via an on/off adjustment button of output components of the computing device.

16. The method of claim 9, wherein the light conditions are detected via a third capturing/sensing component, wherein the third capturing/sensing component includes a light sensor, wherein the smart glass is powered via a power source of the computing device.

17. At least one machine-readable medium comprising a plurality of instructions, executed on a computing device, to facilitate the computing device to perform one or more operations comprising:
detecting light conditions in relation to the computing device including wearable glasses, wherein the wearable glasses include a smart glass, wherein detecting further includes detecting a change in the light conditions;
evaluating influences of the change in the light conditions; and
facilitating, based on the change in the light conditions, turning on or off of the smart glass.

18. The machine-readable medium of claim 16, wherein the turning on of the smart glass corresponds to turning on of potential adjustments to transparency of the smart glass, wherein the turning off of the smart glass facilitates a default position of the transparency of the smart glass, wherein the computing device further comprises a head-mounted display or a smart window.

19. The machine-readable medium of claim 16, wherein the one or more operations comprise facilitating an adjustment to the transparency based on the evaluated influence, wherein the influence includes causing difficulty or ease in viewing contents via a display screen of the computing device, wherein the display screen includes a transparent glass display screen.

20. The machine-readable medium of claim 19, wherein the transparency of the smart glass is lowered if the influence causes difficulty in viewing the contents such that the smart glass is darkened to allow a darker background to facilitate a clear view of the contents, wherein the transparency of the smart glass is raised if the influence causes ease in viewing the contents such that the smart glass is set closer to the default position.

21. The machine-readable medium of claim 16, wherein the one or more operations comprise detecting, via a first capturing/sensing component, a voice command from a user of the computing device to facilitate a voice command-based adjustment to the transparency of the smart glass, wherein the first capturing/sensing component includes a microphone.

22. The machine-readable medium of claim 16, wherein the one or more operations comprise detecting, via a second capturing/sensing component, a gesture command from a user of the computing device to facilitate a gesture command-based adjustment to the transparency of the smart glass, wherein the second capturing/sensing component includes a camera.

23. The machine-readable medium of claim 16, wherein the one or more operations comprise facilitating a manual adjustment of the transparency of the smart glass, wherein the manual adjustment is facilitated via an on/off adjustment button of output components of the computing device.

24. The machine-readable medium of claim 16, wherein the light conditions are detected via a third capturing/sensing component, wherein the third capturing/sensing component includes a light sensor, wherein the smart glass is powered via a power source of the computing device.
